(19) United States
(12) Patent Application Publication
(10) Pub. No.: US 2017/0338684 A1
(43) Pub. Date: Nov. 23, 2017

(54) SYSTEM FOR CHARGING ELECTRONIC DEVICES

(71) Applicant: PowerbyProxi Limited, Freemans Bay, Auckland (NZ)

(72) Inventors: Fady MISHRIKI, Freemans Bay, Auckland (NZ); Benjamin Martin KING, Freemans Bay, Auckland (NZ); Henry WICKHAM, Freemans Bay, Auckland (NZ)

(73) Assignee: PowerbyProxi Limited, Freemans Bay, Auckland (NZ)

(21) Appl. No.: 15/526,726

(22) PCT Filed: Nov. 12, 2015
(86) PCT No.: PCT/NZ2015/050190

§ 371 Date: May 12, 2017

Related U.S. Application Data
(60) Provisional application No. 62/079,492, filed on Nov. 13, 2014.

(51) Int. Cl. H02J 7/02; H04B 1/3827; H02J 50/80; H02J 7/00; H02J 50/10; H04B 5/00

(52) U.S. Cl. CPC H02J 7/025; H02J 7/0052; H02J 50/10; H04B 1/3827; H02J 50/80; H02J 7/0042; H02J 7/0027; H04B 5/0037; H04B 5/0075

(57) ABSTRACT

A system for charging electronic devices, the system comprising: one or more wireless power transmitters 202, each transmitter having one or more power transmitting elements 212; one or more receiver electronic devices 204 including wireless power receivers, each receiver having one or more power receiving elements 216, the transmitters 202 and receivers 204 being configured to transfer electrical power wirelessly between the transmitting 212 and receiving 216 elements; and one or more non-receiver electronic devices configured to receive electrical power from a power supply via a wired connection, wherein the one or more transmitters 202 are configured to receive electrical power from the power supply via the wired connection of the one or more non-receiver electronic devices.

### FIELD OF THE INVENTION

The present invention is in the field of wireless power transfer. More particularly, but not exclusively, the present invention is directed to systems and methods for wirelessly powering and charging consumer electronic devices.

### BACKGROUND OF THE INVENTION

Many consumer electronic devices are portable and as such require rechargeable sources of electrical power. Generally, consumer devices, and the methods and systems for their charging, are designed in isolation of other consumer devices. This has typically occurred, in part, due to the different specifications of the devices themselves both physical (e.g., the size, dimensions, industrial design) and electrical (e.g., required power levels for operation), and in another part due to the lack of standards or other guidelines constraining design.

Some manufacturers and purveyors of consumer devices use the mechanism of powering and charging their devices as a point of difference in the marketplace from those used in their competitor's products. However, even amongst the different devices of the product lines of individual companies many variations in the manner of powering/charging exist. This can lead to user dissatisfaction particularly in product lines where other forms of interoperability are marketed as a benefit. For example, a consumer may purchase several products from the one company or brand in order to enjoy the interoperability that is provided, such as, sharing of information, data, images, recordings and/or software purchases across the devices, interaction of the devices with one another for enhanced functionality, etc., but may be required to use separate, individual or grouped means/devices for powering and charging the different products, such as, different power adaptors, connectors, etc., thereby reducing portability.

Increased interoperability of such products, and even products of different manufacturers or brands, could be provided by some commonality in the powering/charging regime. However, such commonality may otherwise hinder the design of the different devices or effect their marketability.

Accordingly, the present invention provides a system for providing a common form of powering and charging different types of consumer devices in a manner which enhances other forms of interoperation between the devices and does not require complete re-design of those devices.

### SUMMARY OF THE INVENTION

According to one exemplary embodiment there is provided a system for power transfer, and method of operating that system.

In one aspect, a system for charging electronic devices is provided in which the system has one or more wireless power transmitters, each transmitter having one or more power transmitting elements, one or more receiver electronic devices including wireless power receivers, each receiver having one or more power receiving elements, the transmitters and receivers being configured to transfer electrical power wirelessly between the transmitting and receiving elements, and one or more non-receiver electronic devices configured to receive electrical power from a power supply via a wired connection. The one or more transmitters are configured to receive electrical power from the power supply via the wired connection of the one or more non-receiver electronic devices.

The one or more receiver devices may be configured to be able to receive electrical power from the power supply via the wired connection of the one or more non-receiver electronic devices.

The wired connection is one or more cables, with each cable having a connector portion. At least one of the connector portions may be adapted to house one of the one or more transmitters and one of the one or more receiver devices may be configured such that the receiver thereof is positioned to transfer power with the transmitter connector portion.

The transmitter connector portion and configured receiver device may physically connect via a magnetic connection.

At least one of the one or more transmitters may be integrated into one of the one or more non-receiver devices.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning, i.e., they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention. In the drawings:

FIG. 1 illustrates a typical application of the present invention;

FIG. 2 illustrates an exemplary configuration of a wireless power transfer system of the present invention;

FIG. 3 illustrates a wired power regime for consumer devices;

FIG. 4 illustrates a wireless power regime for consumer devices according to the present invention;

FIG. 5 illustrates a wireless power transmitter having a wired power supply connection;

FIG. 6 illustrates an example use case in which wireless power receiver devices are being simultaneously charged using the power transmitter of FIG. 5;

FIG. 7 illustrates a power transmitter configured to provide wired powered connection to a non-handheld portable device whilst providing wireless power to receiver devices;

FIG. 8 illustrates a use case of a non-handheld portable device having an integrated power transmitter wirelessly charging a receiver device;

FIG. 9 illustrates a use case of receiver devices being charged by the power transmitter communicating with peripheral devices; and

FIG. 10 illustrates an example embodiment of the wireless power-scape providing interoperability and management of the charging of receiver multiple devices.

### DETAILED DESCRIPTION OF EMBODIMENTS OF THE INVENTION

Inductive power transfer (IPT) technology is an area of increasing development and IPT systems are now utilised in a range of applications and with various configurations. One such application is the use of IPT systems in so-called ‘charging mats’ or ‘pads’. Such charging mats will normally provide a planar charging surface onto which portable electronic devices may be placed to be charged or powered wirelessly. Typically, the charging mat includes a power transmitter having one or more transmitting coils arranged parallel to the planar charging surface of the charging mat. The transmitter drives the transmitting coils so that the transmitting coils generate a time-varying magnetic field in the vicinity of the planar surface. When portable electronic devices are placed on or near the near the planar surface, the time-varying magnetic field will induce an alternating current in the receiving coil of a suitable receiver associated with the device (for example, a receiver incorporated into the device itself). The received power may then be used to charge a battery, or power the device or some other load.

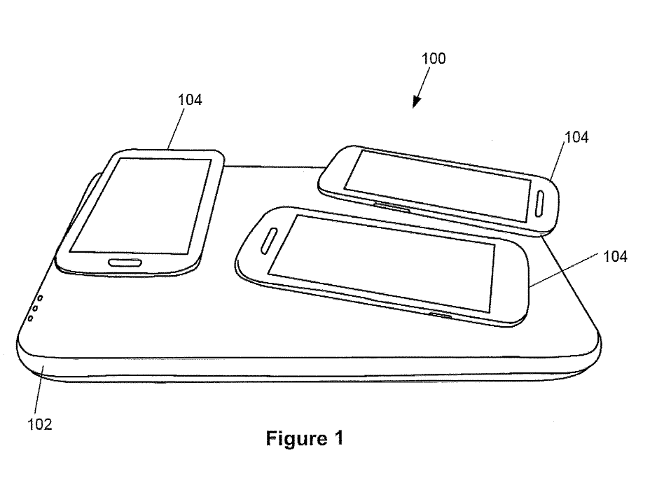

FIG. 1 illustrates a typical application of an IPT system 100 of the present invention. A transmitter or charging pad 102 has a plurality of consumer electronic devices 104 disposed thereon so that electrical loads or energy storage elements, e.g., batteries, of the devices can be charged with electrical power in a wireless or contactless manner where the transmitter is configured to independently charge the multiple receiver devices. In the illustrated example, the electrical power is provided between the pad and devices via an IPT field using loose-coupling techniques between transmitter and receiver electronics. However, other types of wireless power transfer may be possible for such a system, such as capacitive power transfer.

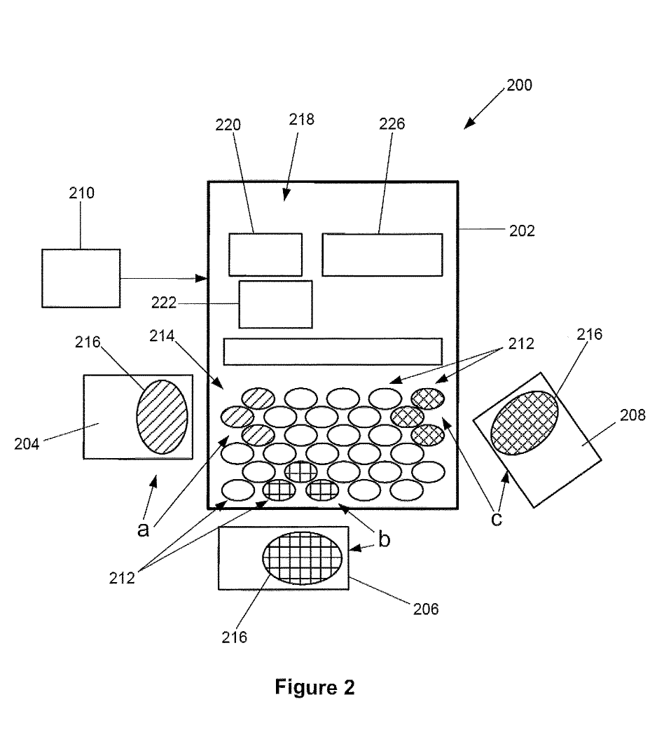

Exemplary configurations of the wireless power transfer system include those described in the Applicant's previous patent applications PCT Publication No. WO 2014/070026 and U.S. Provisional Patent Application No. 62/070,042 entitled System and Method for Power Transfer filed 12 Aug. 2014, the contents of which are both expressly incorporated herein by reference. For example, FIG. 2 illustrates an IPT system 200 as disclosed in US Provisional Patent Application No. 62/070,042. In the system 200, a transmitter 202 is provided which is configured to transfer power to multiple receivers 204, 206 and 208. In this example, three receivers are shown of a consumer device configuration, such as the ‘smartphones’ shown in FIG. 1, placed on the transmitter pad, however it will be understood by those skilled in the art based on the following description that the ‘pad’ of the transmitter can be scaled so as to accommodate and power two or more receiver devices of the same types or of different types, e.g., plural phones, phablets, tablets, laptops, combinations of these, etc., each having respective spatial dimensions and power levels, e.g., a smartphone may require about 5 Watts to about 7.5 Watts of power whereas a tablet may require about 15 Watts of power in order to charge the respective batteries.

The transmitter 202 is illustrated in block diagram form showing its electronics and components. Power for transfer to the receivers is input to the transmitter from a power supply 210. The power supply 210 may supply either AC or DC power to the transmitter 202. The power supply 210 may be, for example, AC power from Mains or DC power from batteries, a regulated DC power supply or a USB power connection to an adaptor, PC or the like, and the input method may be via a wired or wireless connection (as discussed later). In any case the circuitry of the transmitter 202 converts the input power into suitable signals for transfer via power transmission elements 212. The transmission elements 212 are provided in an array 214. As shown, the transmission elements 212 are configured so that one or more of the elements are employed to transmit power to a receiving element 216 of one of the receiver devices 204-208.

As understood by those skilled in the art, in IPT the transmission and receiving elements are inductive elements provided as primary (transmission) coils and secondary or pick-up (receiving) coils which are inductively coupled to one another when in proximity and between which power is transferred via a magnetic field induced when an alternating current (AC) is passed through the transmission coils. In the depiction of FIG. 2, the receiver coils 216 are shown remote from the transmission coils 212 with the groups of coupled transmitter and receiver coils illustrated with like hatching; this is only for ease of explanation and in operation the receiver coils overlay the transmitter coils with which they are coupled.

It is understood that the use of the term “coils” herein is meant to designate inductive “coils” in which electrically conductive wire is wound into three dimensional coil shapes or two dimensional planar coil shapes, electrically conductive material is fabricated using printed circuit board (PCB) techniques into three dimensional coil shapes over one or plural PCB ‘layers’, and other coil-like shapes. The use of the term “coils” is not meant to be restrictive in this sense. Further, the transmitter and receiver coils are depicted as being generally oval in shape in the two dimensions shown in FIG. 2; this is merely exemplary and other two dimensional shapes are possible such as circular, triangular, square, rectangular, and other polygonal shapes, where such shapes are conducive to the array configuration, as explained in more detail later.

In order to allow efficient operation of the system, it is necessary for the transmitter 202 to only power those transmitter coils 212 which can be coupled to the receiver coils 216 of the proximate receiver devices. In this way, the supplied power is used for power transfer to the receiver(s) and not to power the transmitter coils themselves. This selective operation requires knowledge of the positioning of the receiver coils in relation to the transmitter coils, which will be explained in detail later.

The simplest way to selectively power the multiple transmitter coils of the array 214 is to provide driving electronics dedicated to each coil, or at least groups of coils in the array. Whilst this solution is simple, the amount of electronic circuitry required is high leading to added circuit complexity, size and cost. Increased circuit complexity means that higher component counts are required which increases possible losses in the circuitry in conflict with the efficiency required for effective IPT. Increased cost is particularly a concern for the consumer electronics industry in which the financial margins for manufacturers and vendors are small and therefore need to be optimised. Accordingly, the IPT transmitter may utilise driving electronics which is common to all of the transmitter coils. This simplifies the circuitry required but increases the complexity of the manner of controlling the driving circuitry. This increased control complexity is tolerable however when suitable control methods for detecting receiver devices and selecting applicable transmitting coils for powering those detected devices are used, such as those disclosed in previously cited PCT Publication No. WO 2014/070026 and U.S. Provisional Patent Application No. 62/070,042. Independent of the transmitter configuration, it is important that the system discern objects near the charging pad as either a receiver or some other (metallic) object which should not be powered, i.e., a so-called “foreign object” or “parasitic load”, in order to avoid undesirable heating of such an object. Various methods are known for such detection of, and distinction between, “friendly” (e.g., a receiver) and foreign objects, and are equally applicable to the present invention.

The transmitter driving electronics is illustrated in FIG. 2 as driving or control circuitry 218. The control circuitry 218 includes a controller 220, a transmitted power conditioner 222 and a selector 224. The controller 220 may be provided as a digital controller in the form of a programmable integrated circuit, such as microcontroller or microprocessor, or as an analog controller in the form of discrete circuit components.

The transmitted power conditioner 222 is used to condition the input power for driving the transmitter coils, accordingly the configuration of the transmitted power conditioner 222 depends on the power supply 210 used and the requirements of the transmitter coil circuitry. For example, if the power supply 210 supplies DC power, the transmitted power conditioner 222 is a DC-AC inverter with a power rectification function, whereas if the power supply 210 supplies AC power, the transmitted power conditioner 222 is a combination of an AC-DC converter with a power regulation function and a DC-AC inverter with a power rectification function thus providing AC to AC power conditioning via a DC transmission link. It is possible to configure the transmitted power conditioner 222 as a direct AC-AC converter when the power supply 210 supplies AC power, however such direct converters are typically not suitable for IPT applications due to the inability to generate high frequency outputs. The power rectifying DC-AC inverter may be provided as a switch-based rectifier, such as a half-bridge rectifier or full-bridge rectifier having switches, such as diode based switches, or semiconductor switches, such as transistors, field-effect transistors (FETs) or Metal-Oxide-Semiconductor FETs (MOSFETs), in either non-synchronous or synchronous configurations, as is well known to those skilled in the art. The power regulating DC-AC converter may be provided as an AC-to-DC converter (ADC) combined with a step-up (Boost) converter, a step-down (Buck) converter, a Buck-Boost converter, or other converter type suitable for regulating the power in the specific application of the system 200.

The selector 224 may be provided as a battery or array of switches separate from, and connected to, the respective transmitter coils 212 or as switches separately integrated with the coils 212 in respective transmission circuits. The selector 224 may also include a demultiplexer and shift register for driving the switches in a manner well understood by those skilled in the art. The array 214 of transmitter coils 212 may be configured in a number of ways. The transmitter coils may be configured to have substantially the same dimensions and configuration as the receiver coils, such that coupled pairs of transmitter and receiver coils is possible. Alternatively, the transmitter coils may be configured to be larger or smaller than the receiver coils and/or to have a different configuration as the receiver coils. Indeed, different types of receiver devices may have differently dimensioned and configured receiver coils, such that a combination of these relative configurations are to be supported by the system and method of the present invention.

In the example of FIG. 2, the transmitter coils 212 are illustrated as being smaller in dimension than the receiver coils 216 but of the same configuration, i.e., generally oval. In such a configuration, plural transmitter coils 212 can be coupled to a respective receiver coil 216, illustrated as the hatched transmitter coil groups 212a, 212b and 212c. The use of multiple transmitter coils to power a single larger receiver coil optimises the amount of power transferred through efficient use of the transmitter and driving circuitry. As illustrated in FIG. 2, the transmitter coils of the groups are selected based on the disposition of the overlying receiver coil, including the relative orientation.

The array 214 of FIG. 2 is the simplest form of arranging the transmitter coils 212. That is, a repeated pattern of transmitter coils is provided in a single layer or plane with each coil being generally co-planer with all the other coils of the array. Whilst this configuration provides benefits in simplicity, other configurations of the array are possible, including multiple-layered or multiple-planar arrays of coils with or without interlayer offsets or overlaps of regularly or irregularly arranged transmitter coils. Such increased complexity arrays provide other benefits such as improved uniformity in the coupling magnetic field.

With further reference to FIG. 2, the transmitter 202 also includes instrumentation 226 for use by a user of the system 200. The instrumentation 226 may include user controls, such as buttons, and/or indicators, such as light emitting diodes (LEDs), as illustrated in FIG. 1. The instrumentation 226 may be connected to, and controlled by, the controller 220 or other control circuitry as applicable for the input and output of information regarding the operation of the system.

As previously stated, the transmitter can accommodate and power two or more receiver devices of the same types or of different types. In this context, the system of the present invention is able to identify the ‘type’ of receiver device being presented to the transmitter and support the charging of plural ‘types’ of receiver device through this identification. This can be achieved by the receiver device identifying itself to a transmitter and/or vice versa using identification codes. In order to detect where a receiver device is located on the transmitter surface and identify that receiver device, a communications protocol between the transmitter and the receiver(s) can be used in which either a (first) data communications channel separate from the IPT system can be employed, such as those already available to the consumer device, e.g., radio frequency (RF), telecommunications, Wi-Fi, Bluetooth™, etc., or the IPT field itself can be employed to provide a (second) power (IPT) communications channel, e.g., by modulating the transmitted field signal and/or the reflected received field signal using frequency modulation (FM), amplitude modulation (AM), phase modulation (PM) or a combination thereof. Many mechanisms are known for achieving such IPT modulation and possible exemplary mechanisms include those described in the Applicant's previous patent applications U.S. Provisional Patent Application No. 62/070,042 (cited earlier) and U.S. Provisional Patent Application No. 62/074,747 entitled Method and System of Communication filed 4 Nov. 2014, the contents of which is expressly incorporated herein by reference.

As discussed earlier, when a receiver device is brought into coupling proximity of the transmitter of the system the presence, relative location and identity of the receiver device is first ascertained before powering/charging of the receiver device is allowed/enabled. This functioning not only assists spatial freedom of device placement on the transmitter and the simultaneous charging of multiple devices, but also ensures that the devices are powered/charged in a compatible manner. One functional difference between different types of receivers, other than power levels, etc., is the inclusion of power flow control in the receiver-side as opposed to only in the transmitter-side of the system, for example. That is, power flow control may be provided through the communications between the receiver and the transmitter where the transmitter responds to such communication from the receiver for changes in transmitted power by altering the amount of power being transmitted and/or may be provided in the receiver itself.

Power flow control is necessary in a dynamic system in which the relative positioning and type of receiver is unknown in order to ensure that the load of the receiver device, such a rechargeable battery, is not overcharged or undercharged and so that transmitted power is not unduly and undesirably wasted or causes unwanted heating, since this would reduce the system efficiency and may cause safety issues. Exemplary forms of the received power management circuitry include the tuning circuitry and power regulation configurations disclosed in the Applicant's previous patent applications, US Provisional Application Nos. 61/930,191 and 61/990,409 both entitled Coupled-Coil Power Control for Inductive Power Transfer Systems and filed 22 Jan. and 8 May 2014, respectively, and New Zealand Provisional Application Nos. 617604, 617606 and 620979 entitled Power Receiver Having Magnetic Signature And Method Of Operating Same, Contactless Power Receiver And Method of Operating Same, and Inductive Power Receiver With Resonant Coupling Regulator, respectively, and filed 11 Nov. 2013, 11 Nov. 2013 and 7 Feb. 2014, respectively, the contents of which are all expressly incorporated herein by reference.

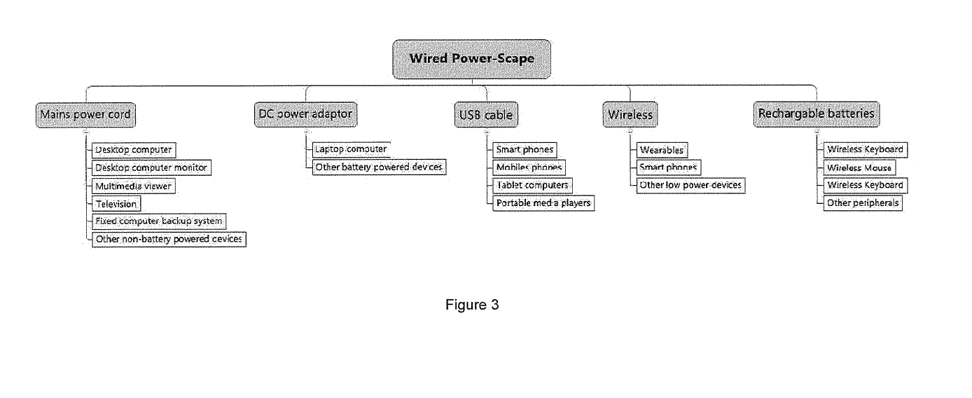

The afore-described IPT system enables a wireless power interoperability environment or “power-scape”. FIG. 3 illustrates a conventional power regime for consumer devices that are able to interoperate through various means, such as sharing data and leveraging functionality. As can be seen in this conventional power-scape many of the devices have a different mechanism for providing power/charge thereto. The power connections in the conventional wired power-scape are as listed in Table 1, where:
(A) is Mains power directly connected using power cord;
(B) is Mains power indirectly connected using adaptor unit and cable connection (with or without power cord);
(C) is DC power directly connected using cable connection;
(D) is a custom wireless power system; and
(E) is an external battery unit.

TABLE 1
Wired Power-Scape

| Device Type | Examples | Connection |
|---|---|---|
| non-battery powered | PCs, external hard drives, connection | (A) |
| or stationary | units, monitors, whiteware | |
| Non-handheld portable | laptop computers | (B) |
| Handheld portable | smartphones, tablets, music players, | (B) or (C) |
| | gaming devices | |
| Wearable | smart-watches, headphones | (C) or (D) |
| Peripheral | wireless keyboard, wireless mouse | (D) or (E) |

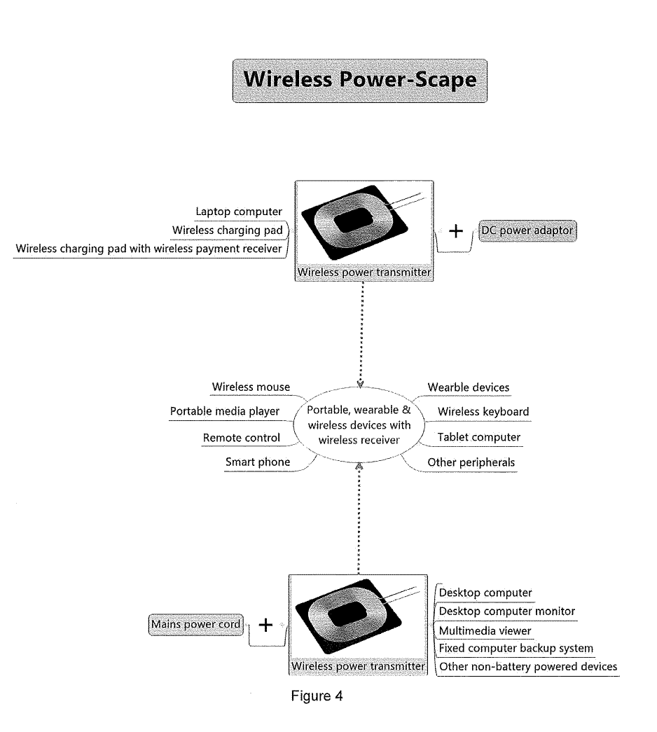

On the other hand, FIG. 4 illustrates an improved power-scape provided by the present invention. As can be seen in the power-scape of the present invention many of the devices of FIG. 3 are able to share a common mechanism for providing power/charge thereto due to the integration and use of the wireless power transfer system. The modifications to the devices and power connections in this wireless power-scape are as listed in Table 2 (the device examples of Table 2 are the same as Table 1) where:
(F) is a common wireless power system.

TABLE 2
Wireless Power-Scape

| Device Type | Modification | Connection |
|---|---|---|
| non-battery powered | integrated wireless power | (A) |
| or non-stationary | transmitter | |
| Non-handheld portable | integrated wireless power receiver | (B) + (F) |
| Handheld portable | integrated wireless power receiver | (B) or (C) + (F) |
| Wearable | integrated wireless power receiver | (B) or (C) + (F) |
| Peripheral | integrated wireless power receiver | (B) or (C) + (F) |

As can be seen from a comparison of Table 1 and Table 2 many more connections are shared between the different types of devices in the wireless power-scape. This in part is facilitated by integrating wireless power capabilities into the existing devices according to the type of device, but is also facilitated by utilizing the existing wired power connections (with or without modifications discussed later) for powering the transmitter-side of the wireless power transfer system.

With respect to integrating a power transmitter into non-battery powered or non-portable devices, this can be done by integrating the electronic components of the transmitter ‘pad’ described earlier into those devices in a manner which allows wireless power transfer to proximate receiver devices. In this configuration the Mains power cord remains the power supply connection to the transmitter device itself, however the other connections described below are also possible for further commonality.

With respect to integrating a power receiver into non-handheld and handheld portable, wearable and peripheral devices, this can be done by integrating the electronic components of the receiver described earlier into those devices in a manner which allows wireless power transfer from proximate transmitter devices. Accordingly, such receiver devices can be wirelessly powered/charged by the wireless power enabled non-battery powered or non-portable devices and by the transmitter pad described earlier. Advantageously, the indirect Mains power connection using an adaptor unit and cable connection (with or without the power cord) and the DC power connection using a cable connection used for the conventional non-handheld and handheld portable, wearable and peripheral devices can be used as the power connection to the transmitter pad (e.g., as power supply 210 in FIG. 2) as well as possible wired power connections to the receiver devices if desired. This means that already developed and shared connection types are retained, reducing the time and cost of adopting the system of the present invention.

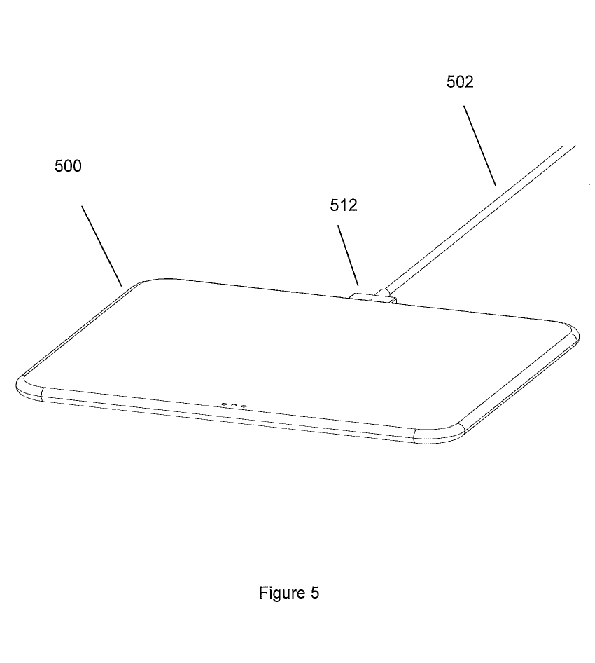

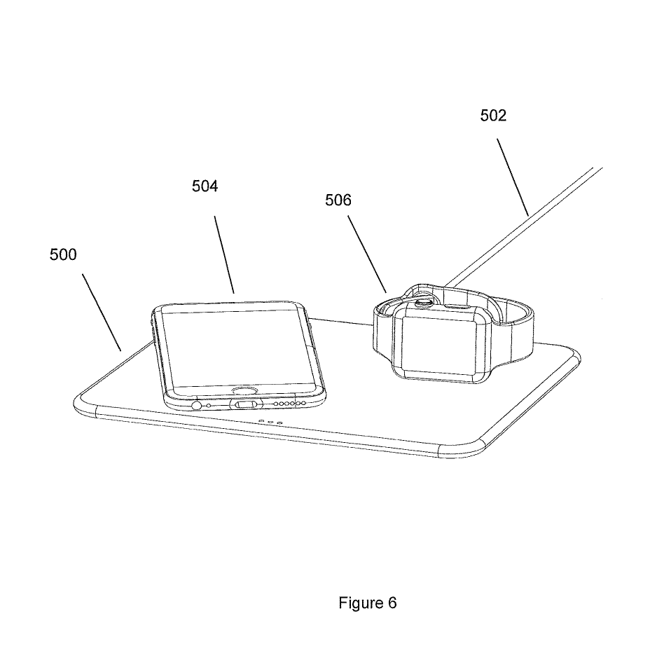

FIG. 5 illustrates an example power transmitter pad 500 having a wired power supply connection 502 that is conventionally used for non-handheld and handheld portable devices, and FIG. 6 illustrates an example use case in which a handheld portable device 504 and a wearable device 506 are being simultaneously charged using the transmitter pad 500 of FIG. 5. In this way, the handheld portable and wearable devices which would otherwise require different power connectors can use the same connection type/connector 502.

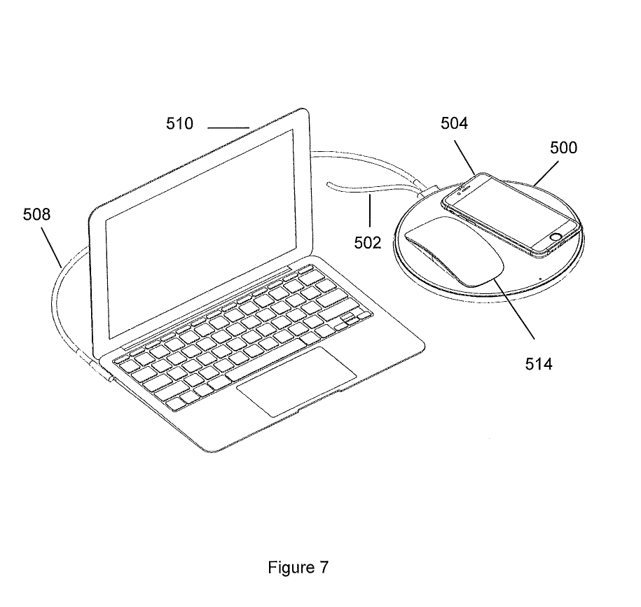

FIG. 7 illustrates another advantageous embodiment of the present invention in which the transmitter pad 500 is configured to provide wired powered connection 508 to a non-handheld portable device 510 (or a non-battery powered or stationary device) whilst providing wireless power connection to handheld portable and peripheral devices 504, 512. This can be achieved by providing through-connection of the power supplied to the transmitter pad by the wired power supply connection 502 to the wired powered connection 508 with any necessary regulation/rectification provided by the transmitter electronics. In this way, the transmitter pad can be retained in a relatively compact manner whilst allowing powering/charging of more devices than can be physically placed on the pad and whilst allowing the non-handheld and handheld portable and wearable devices which would otherwise require different power connectors to use the same connection type.

As an alternative embodiment, the typical wired connector can itself be configured as a wireless power transmitter or transceiver. In this way, the typical power connection hole, slot, etc., in the devices (including the power transmitter pad) is replaced with a wireless power receiver. The electronic configuration of such a wireless power connection apparatus can be relatively simple because the distance between the transmitting and receiving coils (so-called “z-height”) is fixed and relatively small, i.e., about 0.5 mm to about 2.0 mm, such that dynamic changes in the operating/system frequency which occurs in an unconstrained wireless power system (as described earlier) are eliminated thereby requiring simpler power flow control. In this way, the wireless power transfer electronics such as the transmitting coil and associated electronics (as described earlier) in miniaturized form could be housed in a terminal 514 of the connector 502 itself (see FIG. 5). The fixed connection distance can be provided for example by magnetic connection. This would allow the elimination also of breaches within the housings/casings of the devices which could improve lifetime and maintenance issues, e.g., the devices could be substantially hermetically sealed thereby providing water-proofing and dust-proofing.

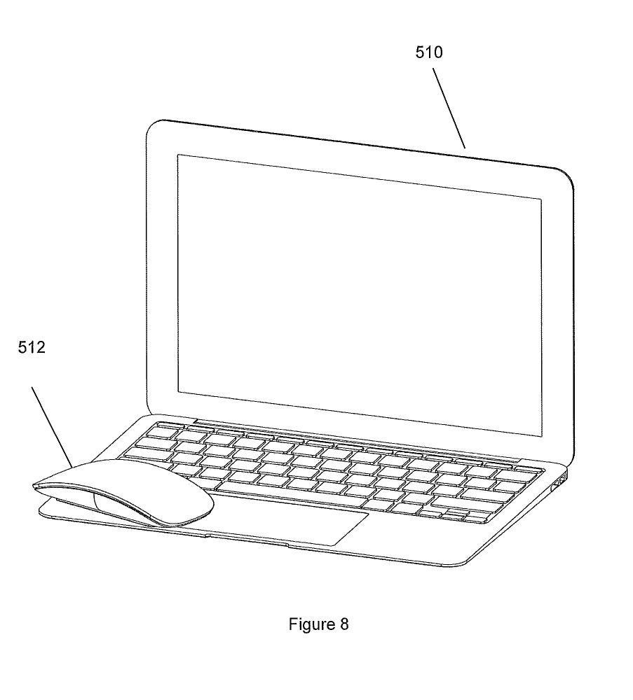

FIG. 8 illustrates another embodiment of the present invention in which a wireless power transmitter is also integrated into a non-handheld portable device 510 so that wireless charging of the peripheral device 512 (as depicted), or a handheld portable or wearable device, having an integrated receiver device can take place. This can be achieved by providing separate transmitters and receivers in the non-handheld portable device, where the receiver is powered from the wired/wireless power supply (e.g., a so-called “repeater” configuration) or from the battery of the non-handheld portable device, or by providing a transceiver (e.g., a so-called bi-directional configuration). This arrangement could also be provided in the handheld portable devices, for example.

The afore-described embodiments of the present invention provide a mechanism for providing re-use of conventionally used plural wired connections/connectors for plural device types within a wireless power transfer system so that interoperability of the device types is enhanced. Further, enhancement of this interoperability can be provided as follows.

The different device types discussed may be those that share information and functionality as discussed earlier. This interoperability may be provided by hardware and/or software available to the devices, and may encompass entertainment content, operational content (such as software updates), user account access and maintenance, etc. For example, with respect to an entertainment system, a software interface may be loaded on one or more of the devices using an electronic memory of the devices or may be accessible by the devices using the communication channels available to the devices. The software interface may provide access to one or more repositories of entertainment content, such as digital music, films, etc., that the user and/or owner of the devices can reproduce or execute (e.g., play) using one or more of the devices. The hardware interface may be, for example, a non-battery powered or stationary device, such as a connection unit dedicated for access to the software interface. In the wired power-scape, access to this entertainment system is typically made at each individual device using various mechanisms. Further, specific and connected (either wired or wireless) data communication interactions are typically required between the individual devices in order to synchronize operation and configuration of the devices and to allow basic functionality. For example, information may not be able to be shared by different devices without those devices being connected to a separate device at some point in order to provide data transfer.

As the power transmitter pad of the present invention provides a central means of powering/charging many of such devices of a user, in a further embodiment of the present invention the power transmitter and/or receiver are configured as an interoperation apparatus or “hub”, such that the wireless power-scape operates as a network for the devices. The electronics of the power transmitters is configured in a manner understood by those skilled in the art to communicate with the receiver and non-receiver devices in the network and to communicate with an external host server having a database or central repository which hosts the software interface data. This can be done by one or more of a:
personal area network (PAN)
   short range networks between
      power transmitters and devices; and
      devices and devices
   for example, Bluetooth™, Iransferiet™, near-field communication (NFC), communications via IPT field
local area network (LAN)
   medium range networks between:
      power transmitters and routers;
      devices and routers;
      routers and routers; and
      power transmitters and devices
   for example, wired (e.g., Ethernet), wireless (e.g., Wi-Fi)
wide area network (WAN)
   long range networks connecting:
      power transmitters, routers and devices to the Internet
   for example, wired (e.g., ADSL, etc.), wireless (e.g., LTE, 3G, etc.)

The power transmitter may be configured within this network to provide the means for the receiver devices to communicate and/or synchronize with the host server, non-receiver devices, and/or one another.

In one example, each power transmitter pad or device (such as the non-battery powered or stationary devices having an integrated power transmitter) is configured with an access code or key, which is required for receiver device communications with the host server or the local software interface loaded on the non-battery powered or stationary devices in the network. Accordingly, the receiver devices are configured to communicate data access requests to the power transmitter either via the IPT or data communications channels. Use of the afore-described identification codes in the power transmitters and receivers may be used as understood by those skilled in the art to facilitate these data access requests. Thus, when the receiver devices are brought into power transfer proximity with the power transmitters of the network a communication link therebetween is established/negotiated on the basis of the identification codes and any data access requests from the power receiver are routed to the host server or networked non-receiver devices by the power transmitter using the access code alone or together with the identification code of the transmitter and/or receiver.

This example could be implemented in a number of ways and could be provided in conjunction with, or in dependence upon, the power transfer or separate therefrom. For example, by using a known relationship between the afore-described power transmitting coil array 212 and the receiver coils 216, such as relative size, dimensions, etc., which may be ascertained by the power transmitter from the decoded identification (or other configuration) code from the power receiver, not only the relative location of the receiver coil(s) but also the relative orientation of the receiver coil(s) to the transmitter coils is deduced by the power transmitter. This relative orientation, for example, is used by the controller of the transmitter to decide whether to adopt certain interoperation modes, such as:
(1) only allow power transfer to the power receiver with no routing of data communications between the receiver device and the host server or other networked devices;
(2) only allow routing of data communications between the receiver device and the host server or other networked devices with no power transfer to the power receiver; or
(3) allow both power transfer to the power receiver and routing of data communications between the receiver device and the host server or other networked devices.

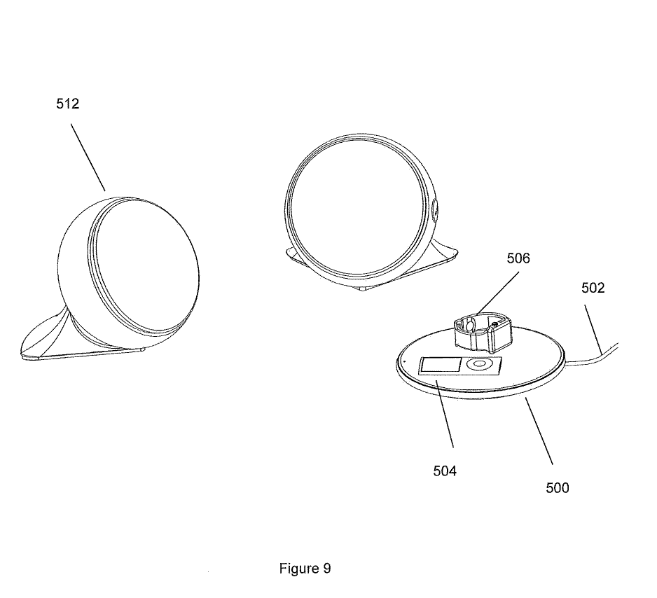

FIG. 9 illustrates a use case of this example in which one or more receiver devices 504, 506 being charged by the power transmitter pad are able to communicate and stream entertainment data to the peripheral devices 512, such as wireless (or wired) speakers, via the power transmitter 500.

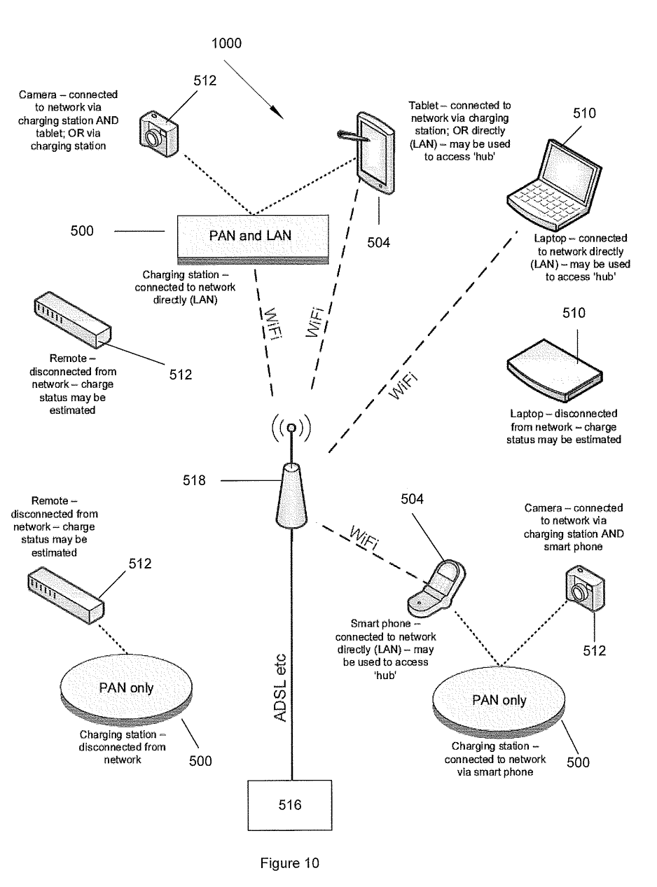

The “hub” embodiment also provides a mechanism for the charge status of the plural receiver and non-receiver devices to be monitored and reported to the user and/or host server. FIG. 10 illustrates an example embodiment of the wireless power-scape 1000 providing interoperability and management of the charging of multiple devices belonging to a user (e.g., their laptop at home, tablet at work, and their smartphone on their person) or within a domicile (e.g., the home). In this example, a database 516 is provided as the host server. The database 518 is part of the charging network which maintains a ‘directory’ of all power transmitters (charging stations) 500, receiver devices 504, 506, 510, 512, and non-receiver devices, such as routers 518, in the network, managed by the identification codes thereof, where registration of these network devices with the directory has been made using the identification codes, for example.

The directory may be maintained by the “hub” which is provided as the database 516 and/or one or more charging stations, devices and/or routers (e.g., a master “unit” may be provided with other units of that type, i.e., charging station, device or router, being slaves; which could be statically or dynamically set), or a combination thereof. The directory may be split across multiple elements or may be duplicated across multiple elements and may be dynamic so as to be constantly or periodically updated.

The provision of the directory allows the charging network to manage the communications and powering/charging of the devices within the network in a number of ways. For example, if a WAN is provided, charging of the receiver devices may be remotely managed (e.g., charge status of devices at home could be reviewed by the user from computer at work). Charging status of each device is communicated to the database 516 or master unit via the charging stations 500, as discussed earlier for example, so that charging status of devices in the network is known and can be estimated if the devices leave or fallout of the network (e.g., receiver enabled car keys are in use or receiver enabled laptops, smartphones are off). Such estimations are calculated using pre-determined configuration data or measured historical data, where the database or master unit maintains a history of charging cycles, battery ages, etc., for each device and other statistics. For example, it may be four months since receiver enabled car keys have been charged on a charging station, so the “hub” may estimate that there is 20% charge left based on known battery life and expected use of the keys.

Access to the “hub” is provided for the user from the receiver devices connected to the network by providing a suitable user interface to control aspects of the charging network. The user interface may be accessible at the master (and slave) unit(s) or may be loaded on/streamed to receiver devices having display means, such as a touchscreen on a smartphone). This allows the user to manage and control the charging of the devices including power/rate/time, the activation of charging stations, and the setting of configuration information. The “hub” may be configured to direct alerts to indicate when charging is required or complete to the user, e.g., via email or simple message service (SMS), and may be enabled to “push” Wi-Fi credentials to receiver devices that are charging.

The charging network of the present invention has been described above in the context of a user oriented or controllable environment. However, it is possible to deploy and configure the charging network in an enterprise environment. In one further embodiment, the charging stations are provided by an enterprise entity in public and/or corporate places, such as point of sale (POS) stations and business infrastructure having power transmitters integrated therein. Accordingly, receiver devices that have been registered with the directory of the charging network, for example, using the identification codes and user interface, receive wireless power charging during transactions with the charging stations through activation upon payment or entering/communicating of a suitable code. Such an enterprise system could collect information and history data from the registered user receiver devices and store that information in the same way as described above, so as to track charging/power usage and enable post-pay account billing, etc.

Whilst the present invention has been illustrated by the description of the embodiments thereof, and while the embodiments have been described in detail, it is not the intention to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the general inventive concept.

1. A system for charging electronic devices, the system comprising:
one or more wireless power transmitters, each transmitter having one or more power transmitting elements;
one or more receiver consumer electronic devices including wireless power receivers, each receiver having one or more power receiving elements, the transmitters and receivers being configured to transfer electrical power wirelessly between the transmitting and receiving elements; and
one or more non-receiver consumer electronic devices configured to receive electrical power from a power supply via a wired connection,
wherein the one or more transmitters are configured to receive electrical power from the power supply via the wired connection of the one or more non-receiver consumer electronic devices.

2. A system as claimed in claim 1, wherein the one or more receiver devices are configured to be able to receive electrical power from the power supply via the wired connection of the one or more non-receiver electronic devices.

3. A system as claimed in claim 2, wherein:
the wired connection is one or more cables, each cable having a connector portion; and
at least one of the connector portions being adapted to house one of the one or more transmitters and one of the one or more receiver devices being configured such that the receiver thereof is positioned to transfer power with the transmitter connector portion.

4. A system as claimed in claim 3, wherein the transmitter connector portion and configured receiver device physically connect via a magnetic connection.

5. A system as claimed in claim 1, wherein at least one of the one or more transmitters is integrated into one of the one or more non-receiver devices.

6. A system as claimed in claim 1, further comprising a transceiver providing bi-directional power transfer between non-receiver consumer electronic devices and/or receiver consumer electronic devices.

7. A system as claimed in claim 1, further comprising a communication link between non-receiver consumer electronic devices and/or receiver consumer electronic devices for routing power commands and/or a data link to an external data connection.

8. A system as claimed in claim 1, wherein the one or more transmitters are housed in a charging pad, the receiver consumer electronic devices including handheld portable devices, wearable devices and/or peripheral devices, and/or the non-receiver consumer electronic devices including non-battery powered or stationary devices, and/or non-handheld portable devices.

9. A charging hub for a number electronic devices, comprising:
a power input circuit for distributing power to one or more wireless transmitters and one or more wired connections;
the transmitter having one or more power transmitting elements configured to transfer electrical power wirelessly to one or more receiver electronics devices;
the wired connection configured to supply electrical power to a non-receiver electronic device.

10. The charging hub of claim 9, wherein the power input circuit comprises on or more of the following: a cable socket for receiving a power supply cable; a second cable socket for receiving a said wired connection to supply a non-receiver device; a selector for switching power distribution to one or more of the wireless transmitters and/or wired connections.

11. The charging hub of claim 10 further comprising a cable connected to the power input circuit and configured to transfer power from a power supply to the charging hub.

12. The charging hub of claim 10, wherein the wired connection comprises a cable for supplying a respective non-receiver device.
